(19) United States
(12) Patent Application Publication
(10) Pub. No.: US 2017/0193700 A1
(43) Pub. Date: Jul. 6, 2017

(54) PROVIDING APPARATUS FOR AUGMENTED REALITY SERVICE, DISPLAY APPARATUS AND PROVIDING SYSTEM FOR AUGMENTED REALITY SERVICE COMPRISING THE SAME

(71) Applicant: ELECTRONICS AND TELECOMMUNICATIONS RESEARCH INSTITUTE, Daejeon (KR)

(72) Inventors: Sung Uk JUNG, Daejeon (KR); Hyun Woo CHO, Daejeon (KR)

(21) Appl. No.: 15/001,414

(22) Filed: Jan. 20, 2016

(30) Foreign Application Priority Data
Jan. 4, 2016 (KR) 10-2016-0000284

(51) Int. Cl. G06T 19/00; G02B 27/01; G06T 17/10

(52) U.S. Cl. CPC G06T 19/006; G06T 17/10; G02B 27/0172; G06T 2207/10028; G06T 2207/10016; G02B 2027/0138; G02B 2027/014

(57) ABSTRACT

A providing apparatus for an augmented reality service includes: a parameter calculating unit calculating camera parameters of a plurality of respective cameras; a mesh information processing unit converting point cloud information based on images obtained from the plurality of respective cameras into mesh information for the plurality of respective cameras and converting the mesh information into a world coordinate for a target space photographed by the plurality of cameras by using the camera parameters; a map generating unit generating a whole map for the target space by considering an area where the converted mesh information for the plurality of respective cameras is duplicated; and an augmentation processing unit augmenting a virtual object to the whole map.

### CROSS-REFERENCE TO RELATED APPLICATIONS

This application claims priority to and the benefit of Korean Patent Application No. 10-2016-0000284 filed in the Korean Intellectual Property Office on Jan. 4, 2016, the entire contents of which are incorporated herein by reference.

### BACKGROUND OF THE INVENTION

1. Field of the Invention

The present invention relates to a providing apparatus for an augmented reality service, a display apparatus and a system for an augmented reality service including the same.

2. Description of Related Art

A general educational augmented reality system separates a user from a camera image and augments a virtual object and a person in a large monitor on the front thereof to draw an educational effect in a virtual environment through interaction with the virtual object. For example, in the case of a 3D based augmented reality system, color and depth images using depth information acquired by using an RGB-D camera are used. Since depth information of a 3D space is used as an input, positional information of an object on a space can be estimated and the estimated positional information is used in the augmented reality system.

However, a conventional system has a disadvantage in that all virtual environments are augmented to a front display and a service is limited when multiple users use the conventional system. That is, since all effects are augmented to one primary display, all users experience an effect only in the display and cannot experience a virtual experience on views other than the display. In order to resolve such a problem, a personal display is required.

However, in the case of a general commercial head mount display, there is a limit in processing a high-performance algorithm due to limited resources (for example, a processing speed, a battery problem, and the like).

### SUMMARY OF THE INVENTION

The present invention has been made in an effort to provide a providing apparatus for an augmented reality service, which can shorten an information processing time, a display apparatus and a providing system for an augmented reality service including the same.

The present invention has also been made in an effort to provide a providing apparatus for an augmented reality service, which can provide the augmented reality service which is a realistic to a user, a display apparatus and a providing system for an augmented reality service including the same.

The objects of the present invention are not limited to the aforementioned objects, and other objects, which are not mentioned above, will be apparent to a person having ordinary skill in the art from the following description.

An exemplary embodiment of the present invention provides a providing apparatus for an augmented reality service, including: a parameter calculating unit calculating camera parameters of a plurality of respective cameras; a mesh information processing unit converting point cloud information based on images obtained from the plurality of respective cameras into mesh information for the plurality of respective cameras and converting the mesh information into a world coordinate for a target space photographed by the plurality of cameras by using the camera parameters; a map generating unit generating a whole map for the target space by considering an area where the converted mesh information for the plurality of respective cameras is duplicated; and an augmentation processing unit augmenting a virtual object to the whole map.

The parameter calculating unit may calculate the camera parameters by using the point cloud information based on the images obtained from the plurality of respective cameras.

The parameter calculating unit may calculate internal parameters and external parameters of the plurality of respective cameras.

The map generating unit may generate the whole map for the target space by simplifying the area where the converted mesh information for the plurality of respective cameras is duplicated.

The providing apparatus may further include a communication unit transmitting information on the whole map, information on the virtual object, and processing information depending on an input of a user for the virtual object to another apparatus.

The plurality of cameras may be RGB-D cameras.

Another exemplary embodiment of the present invention provides a display apparatus including: a communication unit receiving world coordinate information of a target space and whole map information; a camera photographing the target space; a parameter calculating unit calculating camera parameters of the camera; a mesh information processing unit converting point cloud information based on an image obtained from the camera into mesh information and converting the mesh information into a world coordinate by using the camera parameter; a position estimating unit estimating the position of a photographing area of the camera on a whole map by using the converted mesh information and the whole map information; and an augmentation processing unit augmenting a virtual object to the photographing area.

The communication unit may further receive information on the virtual object.

The augmentation processing unit may augment a virtual object that matches the estimated photographing area by using the information on the virtual object.

The parameter calculating unit may calculate the camera parameter by using the point cloud information based on the image obtained from the camera.

The parameter calculating unit may calculate an internal parameter and an external parameter of the camera.

The display apparatus may further include a display unit outputting the photographing area of the camera and the virtual object that matches the estimated photographing area.

Yet another exemplary embodiment of the present invention provides a providing system for an augmented reality service, including: an augmented reality service providing apparatus converting point cloud information based on images obtained from the plurality of respective cameras into mesh information for the plurality of respective cameras, generating whole map information for a target space photographed by the plurality of cameras by using the mesh information for the plurality of cameras, and augmenting a virtual object on the whole map; and a display apparatus estimating a photographing area of a camera on the whole map based on the whole map information transferred from the augmented reality service providing apparatus and augmenting the virtual object to the estimated photographing area.

The augmented reality service providing apparatus may include a parameter calculating unit calculating camera parameters of a plurality of respective cameras; a mesh information processing unit converting point cloud information based on images obtained from the plurality of respective cameras into mesh information for the plurality of respective cameras and converting the mesh information into a world coordinate for a target space photographed by the plurality of cameras by using the camera parameters; a map generating unit generating a whole map for the target space by considering an area where the converted mesh information for the plurality of respective cameras is duplicated; and an augmentation processing unit augmenting a virtual object to the whole map.

The display apparatus may further include: a communication unit receiving world coordinate information of a target space and whole map information; a camera photographing the target space; a parameter calculating unit calculating camera parameters of the camera; a mesh information processing unit converting point cloud information based on an image obtained from the camera into mesh information and converting the mesh information into a world coordinate by using the camera parameter; a position estimating unit estimating the position of a photographing area of the camera on the whole map by using the converted mesh information and the whole map information; and an augmentation processing unit augmenting a virtual object to the photographing area.

According to exemplary embodiments of the present invention, a providing apparatus for an augmented reality service, a display apparatus and a providing system for an augmented reality service including the same can shorten an information processing time.

A providing apparatus for an augmented reality service, a display apparatus and a providing system for an augmented reality service including the same can provide a realistic augmented reality service to a user.

The exemplary embodiments of the present invention are illustrative only, and various modifications, changes, substitutions, and additions may be made without departing from the technical spirit and scope of the appended claims by those skilled in the art, and it will be appreciated that the modifications and changes are included in the appended claims.

### BRIEF DESCRIPTION OF THE DRAWINGS

FIG. 1 illustrates a providing system for an augmented reality service according to an exemplary embodiment of the present invention.

FIG. 2 is a block diagram illustrating a providing apparatus for an augmented reality service according to an exemplary embodiment of the present invention.

FIGS. 3 and 4 are diagrams for describing an operation of a providing apparatus for an augmented reality service according to an exemplary embodiment of the present invention.

FIG. 5 is a block diagram illustrating a display apparatus according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, some exemplary embodiments of the present invention will be described in detail with reference to the exemplary drawings. When reference numerals refer to components of each drawing, it is noted that although the same components are illustrated in different drawings, then same components are designated by the same reference numerals as possible. In describing the exemplary embodiments of the present invention, when it is determined that the detailed description of the known components or functions related to the present invention may obscure understanding the exemplary embodiments of the present invention, the detailed description thereof will be omitted.

Terms, such as first, second, A, B, (a), (b), and the like may be used in describing the components of the exemplary embodiments of the present invention. The terms are only used to distinguish a constituent element from another constituent element, but nature or an order of the constituent element is not limited by the terms. Further, if it is not contrarily defined, all terms used herein including technological or scientific terms have the same meaning as those generally understood by a person with ordinary skill in the art. Terms which are defined in a generally used dictionary should be interpreted to have the same meaning as the meaning in the context of the related art, and are not interpreted as an ideal or excessively formal meaning unless clearly defined in the present application.

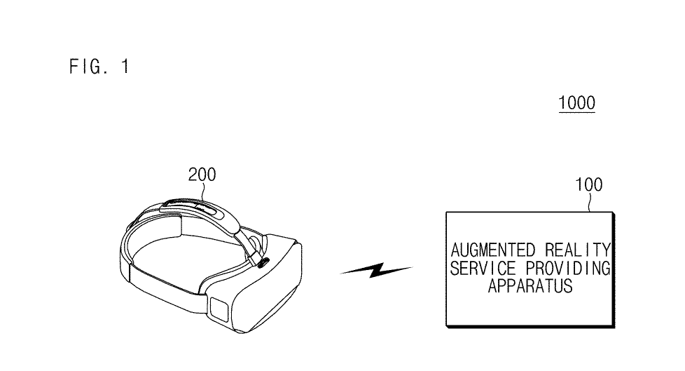

FIG. 1 illustrates a providing system for an augmented reality service according to an exemplary embodiment of the present invention.

Referring to FIG. 1, a providing system 1000 for an augmented reality service according to an exemplary embodiment of the present invention may include an augmented reality service providing apparatus 100 and a display apparatus 200.

The augmented reality service providing apparatus 100 may generate whole map information for a target space for providing the augmented reality service. For example, the augmented reality service providing apparatus 100 may convert point cloud information based on an image for a target space obtained from a plurality of cameras into mesh information for each of the plurality of cameras and generate whole map information for a target space photographed by the plurality of cameras by using the mesh information. The augmented reality service providing apparatus 100 may augment a virtual object to a generated whole map. The augmented reality service providing apparatus 100 may transfer the whole map information and information on the virtual object to the display apparatus 200.

The display apparatus 200 may provide an augmented reality experience to a user by using the whole map information and the information on the virtual object transferred from the augmented reality service providing apparatus 100. For example, the display apparatus 200 may estimate a photographing area of a camera (that is, a camera of the display apparatus 200) based on the whole map information transferred from the augmented reality service providing apparatus 100 and augment and output the virtual object that matches the estimated photographing area.

The display apparatus 200 may be, for example, a see-through type head mount display apparatus. The head mount display apparatus may mean an apparatus that is worn on a head, a face, and the like of a person and allows information on an object included in the image photographed through the camera to be output. For example, the head mount display apparatus according to the exemplary embodiment of the present invention may also be implemented for example in the form of glasses and also implemented in the form that the head mount display apparatus is worn on the head like a helmet.

As described above, the providing system 1000 for the augmented reality service according to the exemplary embodiment of the present invention processes the generation of the whole map information in the augmented reality service providing apparatus 100 and provides the augmented reality service through the display apparatus 200 by using the processed whole map information to shorten a processing time and provide a realistic augmented reality service to the user.

Hereinafter, the augmented reality service providing apparatus 100 and the display apparatus 200 will be described in more detail.

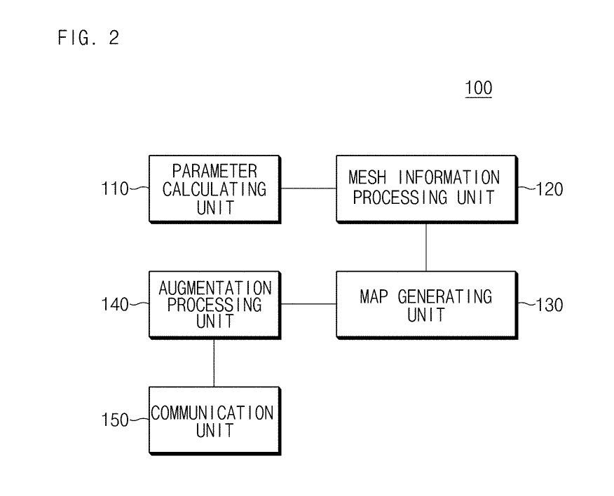

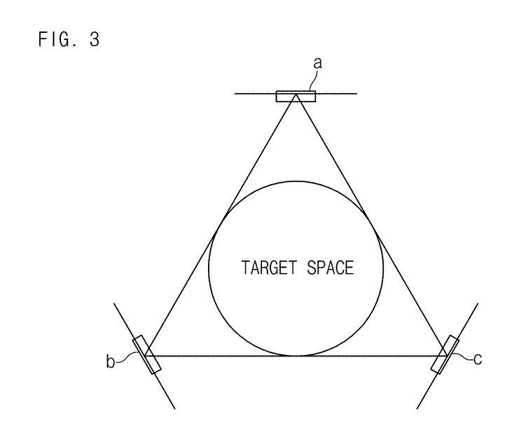

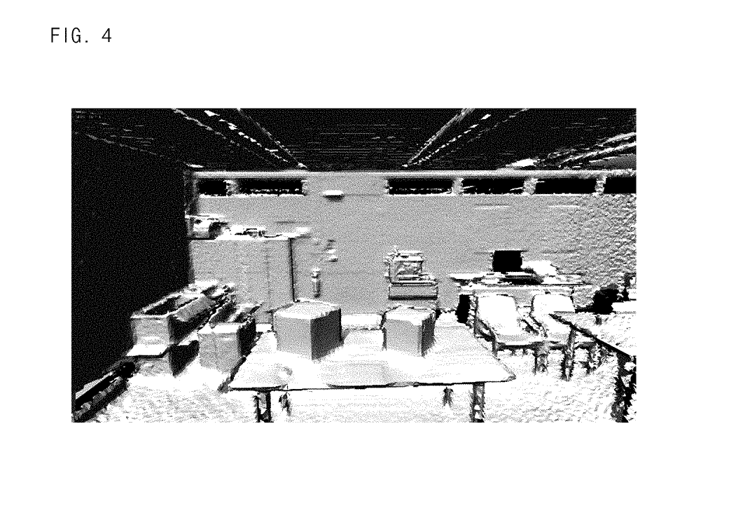

FIG. 2 is a block diagram illustrating a providing apparatus for an augmented reality service according to an exemplary embodiment of the present invention. FIGS. 3 and 4 are diagrams for describing an operation of a providing apparatus for an augmented reality service according to an exemplary embodiment of the present invention.

First, referring to FIG. 2, the augmented reality service providing apparatus 100 according to the exemplary embodiment of the present invention may include a parameter calculating unit 110, a mesh information processing unit 120, a map generating unit 130, an augmentation processing unit 140, and a communication unit 150.

The parameter calculating unit 110 may calculate camera parameters of the plurality of respective cameras. Referring to FIG. 3, the plurality of cameras may be disposed to photograph the target space. In FIG. 3, three cameras a, b, and c are illustrated, but are not limited thereto. For example, the plurality of cameras a, b, and c may be RGB-D cameras. Any one camera among the plurality of cameras a, b, and c may be defined as a reference camera (which does not rotate and is positioned at (0, 0, 0) on a whole map).

The parameter calculating unit 110 may calculate the camera parameters by using the point cloud information based on the images obtained from the plurality of respective cameras. For example, the point cloud information may include depth information for the target space photographed by the plurality of cameras.

The camera parameters may include an internal parameter and an external parameter. For example, the internal parameter may include parameters including a focus distance, a main point, and the like and the external parameter may include parameters including rotation, translation, and the like. For example, the parameter calculating unit 110 may calculate internal parameters of the plurality of respective cameras by using a calibration algorithm of Tsai. For example, the parameter calculating unit 110 may calculate external parameters of other cameras by using an iterative closest point (ICP) algorithm based on the reference camera.

The mesh information processing unit 120 may convert the point cloud information based on the images obtained from the plurality of respective cameras into mesh information for each of the plurality of cameras. Referring to FIG. 4, an example in which the point cloud information is converted into the mesh information by the mesh information processing unit 120 is illustrated.

The mesh information processing unit 120 may convert the mesh information into a world coordinate for the target space photographed by the plurality of cameras by using the camera parameters. In an aspect, it may be appreciated that the mesh information processing unit 120 projects the mesh information for the plurality of respective cameras to the world coordinate for the target space. The mesh information for each of the plurality of cameras may include normal vector information and positional information. Therefore, in the case where the respective mesh information is projected to the world coordinate for the target space, the processing time may be shortened as compared with the case where the point cloud information is directly projected to the world coordinate.

The map generating unit 130 may generate the whole map for the target space by using the mesh information for the plurality of respective cameras, which is converted. For example, the whole map may mean a 3D space map for the target space.

In more detail, the map generating unit 130 may generate the whole map by considering an area where the converted mesh information for the plurality of respective cameras is duplicated with each other. For example, the map generating unit 130 may generate the whole map by simplifying (alternatively, matching (for example, regenerating the area as one mesh information)) the area where the mesh information for the plurality of respective cameras is duplicated with each other. For example, the map generating unit 130 may calculate a distance of a part where the normal vector information and the positional information are duplicated with each other by using the normal vector information and the positional information of each converted mesh information based on the positional information and the normal vector information for the whole target space and determine the area as an area where the mesh information is duplicated when the calculated distance is equal to or less than a threshold value.

The augmentation processing unit 140 may augment the virtual object to a predetermined area on the whole map. For example, an area where the virtual object is augmented, a display format of the virtual object, information on an event associated with the virtual object, and the like may be predetermined.

The communication unit 150 may transfer whole map information, the information on the world coordinate for the target space, the information on the virtual object, and processing information depending on an input of the user for the virtual object to another apparatus (for example, the display apparatus 200). The communication unit 150 may include various wireless communication interfaces.

As described above, since the augmented reality service providing apparatus 100 according to the exemplary embodiment of the present invention converts the point cloud information based on the images obtained from the plurality of cameras into the mesh information and generates the whole map information for the target space by using the converted mesh information, the augmented reality service providing apparatus 100 may shorten the processing time as compared with the case where the whole map information is directly generated by using the point cloud information. That is, since a lot of time is required to process multiple point cloud information based on the images obtained from the plurality of cameras, the whole map information is generated by using the mesh information obtained by simplifying the multiple point cloud information to some degree to shorten the processing time.

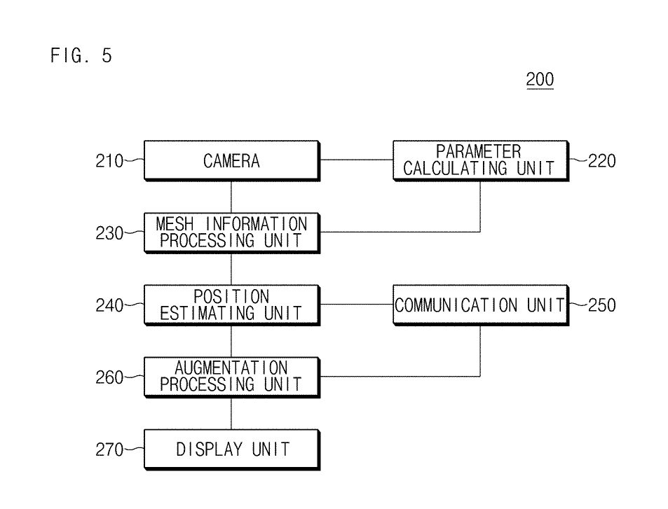

FIG. 5 is a block diagram illustrating a display apparatus according to an exemplary embodiment of the present invention.

Referring to FIG. 5, the display apparatus 200 according to the exemplary embodiment of the present invention may include a camera 210, a parameter calculating unit 220, a mesh information processing unit 230, a position estimating unit 240, a communication unit 250, an augmentation processing unit 260, and a display unit 270.

The camera 210 may photograph, a target space. When the display apparatus 200 is implemented as a head mount display apparatus, the camera 210 may be disposed to photograph the target space from the viewpoint of a user. The camera 210 may include a color camera and a depth camera.

The parameter calculating unit 220 may calculate a camera parameter of the camera. The parameter calculating unit 220 may calculate the camera parameter by using point cloud information based on an image obtained from the camera 210. For example, the point cloud information may include depth information for the target space photographed by the camera 210.

The camera parameter may include an internal parameter and an external parameter. For example, the internal parameter may include parameters such as a focus distance, a main point, and the like and the external parameter may include parameters such as rotation, translation, and the like. For example, the parameter calculating unit 220 may calculate the internal parameter of the camera 210 by using a calibration algorithm of Tsai. For example, the parameter calculating unit 220 may calculate the external parameter of the camera 210 by using an iterative closest point (ICP) algorithm.

The mesh information processing unit 230 may convert the point cloud information based on the image obtained from the camera 210 into the mesh information. The mesh information processing unit 230 may convert the mesh information into a world coordinate for the target space by using the camera parameter. In an aspect, it may be appreciated that the mesh information processing unit 230 projects the mesh information to the world coordinate for the target space.

The position estimating unit 240 may estimate the position of a photographing area of the camera 210 on a whole map for the target space by using the converted mesh information and whole map information. The whole map information may be received from the augmented reality service providing apparatus 100. For example, the position estimating unit 240 may estimate the position of the photographing area of the camera 210 according to two steps. The position estimating unit 240 may estimate a coarse position of the camera 210 on the whole map by using the converted mesh information and the external parameter of the camera 210 and estimate an accurate position of the photographing area of the camera 210 by matching a whole map (mesh map) for the target space and the mesh information of the display apparatus 200.

The communication unit 250 may receive from another apparatus (for example, the augmented reality service providing apparatus 100) world coordinate information of the target space, whole map information, information on a virtual object, and/or processing information depending on an input of a user for the virtual object.

The augmentation processing unit 260 may augment the virtual object to a position estimated as the photographing area of the camera 210. For example, the augmentation processing unit 260 may augment a virtual object that matches the estimated photographing area by using the information on the virtual object, which is received through the communication unit 250.

The display unit 270 may output a virtual object that matches the photographing area of the camera 210 and the estimated photographing area to be augmented.

As described above, since the display apparatus 200 according to the exemplary embodiment of the present invention converts the point cloud information based on the image obtained from the camera 210 into the mesh information and estimates the accurate position of the photographing area on the whole map by using the converted mesh information and the whole map information and augments the virtual object, the display apparatus 200 may shorten the processing time and provide a personalized augmented reality experience to a user who uses the display apparatus 200. That is, the user who wears the head mount display apparatus 200 may execute an input for a virtual object augmented on a view of the user in the target space and an event generation effect depending on the input is processed through the augmented reality service providing apparatus 100 to be transferred and output to the head mount display apparatus 200, and as a result, the user may receive an augmented reality experience which is more rapid and realistic.

The above description is illustrative purpose only and various modifications and transformations become apparent to those skilled in the art within a scope of an essential characteristic of the present invention.

Therefore, the exemplary embodiments disclosed in the present invention are used to not limit but describe the technical spirit and the scope of the technical spirit of the present invention is not limited by the exemplary embodiments. Therefore, the spirit of the present invention should not be limited to the above-described exemplary embodiments, and the following claims as well as all modified equally or equivalently to the claims are intended to fall within the scope and spirit of the invention.

What is claimed is:

1. A providing apparatus for an augmented reality service, the providing apparatus, comprising:
a parameter calculating unit calculating camera parameters of a plurality of respective cameras;
a mesh information processing unit converting point cloud information based on images obtained from the plurality of respective cameras into mesh information for the plurality of respective cameras and converting the mesh information into a world coordinate for a target space photographed by the plurality of cameras by using the camera parameters;
a map generating unit generating a whole map for the target space by considering an area where the converted mesh information for the plurality of respective cameras is duplicated; and
an augmentation processing unit augmenting a virtual object to the whole map.

2. The providing apparatus of claim 1, wherein the parameter calculating unit calculates the camera parameters by using the point cloud information based on the images obtained from the plurality of respective cameras.

3. The providing apparatus of claim 1, wherein the parameter calculating unit calculates internal parameters and external parameters of the plurality of respective cameras.

4. The providing apparatus of claim 1, wherein the map generating unit generates the whole map for the target space by simplifying the area where the converted mesh information for the plurality of respective cameras is duplicated.

5. The providing apparatus of claim 1, further comprising:
a communication unit transmitting information on the whole map, information on the virtual object, and processing information depending on an input of a user for the virtual object to another apparatus.

6. The providing apparatus of claim 1, wherein the plurality of cameras are RGB-D cameras.

7. A display apparatus comprising:
a communication unit receiving world coordinate information of a target space and whole map information;
a camera photographing the target space;
a parameter calculating unit calculating camera parameters of the camera;
a mesh information processing unit converting point cloud information based on an image obtained from the camera into mesh information and converting the mesh information into a world coordinate by using the camera parameters;
a position estimating unit estimating the position of a photographing area of the camera on a whole map by using the converted mesh information and the whole map information; and
an augmentation processing unit augmenting a virtual object to the photographing area.

8. The display apparatus of claim 7, wherein the communication unit further receives information on the virtual object.

9. The display apparatus of claim 7, wherein the augmentation processing unit augments a virtual object that matches the estimated photographing area by using the information on the virtual object.

10. The display apparatus of claim 7, wherein the parameter calculating unit calculates the camera parameters by using the point cloud information based on the image obtained from the camera.

11. The display apparatus of claim 7, wherein the parameter calculating unit calculates an internal parameter and an external parameter of the camera.

12. The display apparatus of claim 7, further comprising:
a display unit outputting the photographing area of the camera and the virtual object that matches the estimated photographing area.

13. A providing system for an augmented reality service, the providing system comprising:
an augmented reality service providing apparatus converting point cloud information based on images obtained from the plurality of respective cameras into mesh information for the plurality of respective cameras, generating whole map information for a target space photographed by the plurality of cameras by using the mesh information for the plurality of cameras, and augmenting a virtual object on the whole map; and
a display apparatus estimating a photographing area of a camera on the whole map based on the whole map information transferred from the augmented reality service providing apparatus and augmenting the virtual object to the estimated photographing area.

14. The providing system of claim 13, wherein the augmented reality service providing apparatus includes:
a parameter calculating unit calculating camera parameters of a plurality of respective cameras;
a mesh information processing unit converting point cloud information based on images obtained from the plurality of respective cameras into mesh information for the plurality of respective cameras and converting the mesh information into a world coordinate for a target space photographed by the plurality of cameras by using the camera parameters;
a map generating unit generating a whole map for the target space by considering an area where the converted mesh information for the plurality of respective cameras is duplicated; and
an augmentation processing unit augmenting a virtual object to the whole map.

15. The providing system of claim 13, wherein the display apparatus includes:
a communication unit receiving world coordinate information of a target space and whole map information;
a camera photographing the target space;
a parameter calculating unit calculating camera parameters of the camera;
a mesh information processing unit converting point cloud information based on an image obtained from the camera into mesh information and converting the mesh information into a world coordinate by using the camera parameter;
a position estimating unit estimating the position of a photographing area of the camera on the whole map by using the converted mesh information and the whole map information; and
an augmentation processing unit augmenting a virtual object to the photographing area.
